(19) United States
(12) Patent Application Publication
(10) Pub. No.: US 2022/0415562 A1
(43) Pub. Date: Dec. 29, 2022

(54) SYSTEM AND METHOD FOR MANUFACTURING A WIRE-WOUND POWER TRANSMISSION DEVICE

(71) Applicant: Foli Research, LLC, Berkeley, CA (US)

(72) Inventors: Samuel Eli Calisch, Berkeley, CA (US); Tucker Roy Gilman, Berkeley, CA (US)

(21) Appl. No.: 17/729,581

(22) Filed: Apr. 26, 2022

Related U.S. Application Data
(60) Provisional application No. 63/179,728, filed on Apr. 26, 2021.

(51) Int. Cl. H01F 27/28; H01F 41/04

(52) U.S. Cl. CPC H01F 27/2828; H01F 41/04; B33Y 10/00

(57) ABSTRACT

A system and method for an additive platform for a wire-wound power transmission construct includes: a wire, comprising an interior metal core, and an adhesive coating; a wire plotting platform, that shapes and deposits the wire in a moving region of wire deposition and a bonding module, comprising components that fix the wire into place. The wire plotting platform may comprise a wire deposition component and a positioning component that includes an actuation system with at least two degrees of freedom. The bonding module may comprise a mechanism that activates the adhesive coating such that the wire anneals to itself, or to other components, in the region of wire deposition concurrent to deposition of the wire by the wire plotting platform. The system functions as a high-speed high-precision additive manufacturing device, wherein the device is suited for the construction of wire-wound power transmission devices.

### CROSS-REFERENCE TO RELATED APPLICATIONS

This application claims the benefit of U.S. Provisional Application No. 63/179,728, filed on 26 Apr. 2021, of which is incorporated in its entirety by this reference.

### TECHNICAL FIELD

This invention relates generally to the field of power transmission and more specifically to a new and useful system and method for manufacturing wire-wound power transmission devices using additive machines.

### BACKGROUND

Wired power transmission has been a technology commonly used and improved upon for hundreds of years. With the discovery of induction, technologies have developed to enable wireless power transmission, particularly through inductors and transformers. As these technologies have improved, devices for power transmission have been produced using more sophisticated materials and incorporated more complex wire windings for better performance. Solid state, high frequency transformers (SSTs), enabled by high electron mobility transistors (HEMTs), are a power conversion technology poised to be a key enabler of the smart grid transition, as they allow dramatic increase in power density, and greatly increased control over flow of power through the network (Nomenclature here is confusing, as “transformer” can refer both to the entire SST device, as well as the conventionally-defined subcomponent transformer, a wire-wound galvanically-isolated voltage converter. We aim to use SST to refer to the device, and “transformer” to refer to the subcomponent.). Faraday's law implies that the power rating of a transformer is proportional to the product of its operating frequency, the core cross sectional area, and the winding cross sectional area. Thus, driving at 10 kHz, instead of the line frequency of 60 Hz offers more than an order of magnitude reduction in required core material, and increasing to 1 MHz offers an additional order of magnitude reduction. These scaling laws are tantalizing, demonstrating a pathway to power conversion devices small and cheap enough to be ubiquitous, with significantly improved abilities to control flow of energy, power factor, voltage regulation, and harmonic distortion. Several converter topologies have been demonstrated with impressive results, including the Dual Active Bridge (DAB), which is inherently bidirectional and galvanically isolated, has high power density and a relatively simple, robust design, and has shown great promise for smart grid applications.

Despite this vision, several key hurdles limit the adoption of SSTs, most related to the transformer lying at their heart. Several loss mechanisms, which are minor concerns at low frequencies, become critical to manage at high frequencies. The electrical steel used in mains transformers incurs significant eddy losses at high frequency, so higher-resistivity ferrite core materials must be used instead. A greater concern, however, are the losses induced by the AC resistance of the transformer windings. At high frequencies, the skin and proximity effects of the conductors can dramatically limit their current carrying capability and parastitics dramatically impact converter performance.

Common approaches for mitigating these AC effects are Litz windings and printed circuit board (PCB) transformers, but these suffer from suboptimal, unreliable performance, and increased costs. In Litz winding transformers, a set of fine insulated wires is twisted together such that over the run of the winding, each wire spends roughly the same time on the outside surface of the bundle as on the inside of the bundle. This allows uniform current sharing between the available copper and ameliorates some of the AC resistance losses. It is not a perfect solution, as the AC resistance ratio (the ratio of AC resistance at a given frequency to the DC resistance) can still be significant (e.g., greater than 10 at 1 MHz for any bundle with 10 strands or fewer). Often the optimal Litz winding for an application consists of hundreds of strands, combined into sub-bundles, which can be difficult and expensive to produce, a factor which must be taken into account when selecting a Litz winding. More critically, if improperly designed, Litz wire (i.e., wire that comprises Litz windings) can have higher loss and higher cost than a single layer winding, and the performance of a Litz wire device can be significantly impacted by how the bundle is wound into a core. This process must be carefully controlled, and often results in winding by hand, at great expense.

In PCB transformers, laminate etching processes developed and scaled for circuit board manufacturing are used to create transformer windings. Layers are built by stacking multiple rigid boards or flexible circuits, and vias are used to pass current between layers. The advantage of this approach is that geometry can be carefully tailored to address the high frequency skin and proximity effects. In particular, primary and secondary windings can be interleaved, which reduces AC resistance. The major drawback of this approach is the low copper fill fraction (i.e., the amount of the winding cross-section actually made up of copper, rather than the fiberglass layers and gaps between conductors imposed by the etching process). Using flexible PCBs on thin substrates can improve this, but this requires laminating many layers to form the device, with costs that increase steeply with the number of layers. The low fill fraction also limits the number of turns achievable in a given winding window, which, by Faraday's Law, requires higher magnetic flux density in the core (holding core area and voltage fixed). Using the Steinmetz equations for core eddy currents and hysteresis, these losses are proportional to magnetic flux density to the powers 2 and 1.6, respectively, for ferrite cores. These losses can be significant for turn-limited PCB transformers, bounding allowable operating frequency. The turn limit also leads to larger PCB footprints; and creates undesirable inter-winding capacitance due to the high aspect ratio traces.

Thus, there is a need for an invention that combines the benefits of Litz winding and PCB-based approaches while reducing their drawbacks. Herein, we disclose the use of an additive manufacturing platform for wire-wound components as a way of combining the best elements of the Litz wire and PCB-based approaches described above, as well as adding fundamentally new capabilities for wire-wound transmission devices, particularly for high frequency transformers.

### BRIEF DESCRIPTION OF THE FIGURES

FIG. 1 is a schematic representation of an example system.

FIG. 2 is a schematic representation of an example wire.

FIG. 3 is a schematic representation of an example wire plotting platform.

FIG. 4 is a schematic representation of an example system that includes a laser.

FIG. 5 is a picture of an example system prototype.

FIG. 6 is a schematic representation of the bottom view of an example plotting head.

FIG. 7 is a schematic representation of a rear view of an example plotting head.

FIG. 8 is a schematic representation of a side view of an example plotting head.

FIG. 9 is a picture of an example plotting head prototype, before installation of the applicator tip.

FIG. 10 is a picture of the example plotting head prototype after installing the applicator tip.

FIG. 11 is a picture of the underside view of a prototype example applicator roller and its bearings, with a wire passing between guides.

FIG. 12 is a picture of an example prototype laser module components.

FIG. 13, is a picture of the example prototype laser module components assembled.

FIG. 14 is a picture of the example prototype laser module installed on the wire plotting machine.

FIG. 15 is a picture of the prototype machine with prototype laser installed, including safety guard and heating bed.

FIG. 16 is a schematic of an example laser prototype laser module, including thermal control and kinematic alignment coupling.

FIG. 17 is a schematic of an example applicator tip, showing the path of a laser down from the laser.

FIG. 18 is an image of a beam hitting the wire as it is leaving as it leaves the guides and before passing over the roller.

FIG. 19 is a picture of a demonstration of a wire stripping implementation.

FIG. 20 is a picture of an example prototype system.

FIG. 21 is a picture of an output interleaved transformer winding, where alternating wires have been used to illustrate the primary and secondary.

FIG. 22 is a sketch of a power converter using an interleaved transformer winding in a slim form factor.

FIG. 23 is a comparison of three winding strategies in a 2:1 transformer, wherein the left column demonstrates conventional windings, the center column demonstrates single interleaving, and the right column demonstrates double interleaving; the top row shows current density at 1 kHz, while the bottom shows current density at 1 MHz.

FIG. 24 are schematic examples of interleaving soft magnetic core 2:1 transformer windings.

FIG. 25 is a flowchart of an example method.

FIG. 26 is a picture schematic of the laser deposition printing process.

FIG. 27 is a schematic of a sample calibrating pattern.

FIG. 28 is a graph comparison of the resistance of different windings for increasing frequencies in a 2:1 transformer.

FIG. 29 is an exemplary system architecture that may be used in implementing the system and/or method.

FIG. 30 is an exemplary system architecture that may be used in implementing the system and/or method.

### DESCRIPTION OF THE EMBODIMENTS

The following description of the embodiments of the invention is not intended to limit the invention to these embodiments but rather to enable a person skilled in the art to make and use this invention.

### 1. Overview

A system and method for manufacturing a wire-wound power transmission device comprises: a wire, comprising a metal core, an insulation coating, and an adhesive coating; a wire plotting platform; and a bonding module. The system and method function to manufacture high precision a wire-wound construct, enabled for wired, and wireless, power transmission. The system and method may be particularly useful for manufacture of wire-wound transformers and inductors. The system and method thus enable construction of high precision, wire-wound transformers with complex winding geometries. In some variations, the adhesive coating is a heat sensitive thermoplastic coating, and the bonding module comprises a laser module. The system and method enable the laser to heat the wire close to the point of wire deposition, thus further improving the positioning and alignment of the wire construct.

The system and method may be implemented for construction of any general wire-wound structure. For construction of transformers, the system and method enable complex windings and interleavings not generally available through current methods, enabling the construction of potentially new generations of transformers. Due to these benefits, the system and method may be particularly useful for the construction wireless transformer patterns.

The system and method may also be incorporated for wire stripping and other types of wire modification. Through high precision laser directionality, the system and method may remove localized, larger, regions of wire coating in an efficient and precise manner with minimal damage to the wire itself.

The system and method may provide a number of potential benefits. The system and method are not limited to always providing such benefits; and are presented only as exemplary representations for how the system and method may be put to use. The list of benefits is not intended to be exhaustive and other benefits may additionally or alternatively exist.

The system and method may enable the benefit of Litz wire while reducing its drawbacks. Like Litz wire transformers, AC losses may be minimized through careful conductor placement. But instead of using a separate process incurring cost and uncertainty, the individual conductors may be cost-effectively and reliably patterned directly into their final form.

The system and method may enable high performance wireless power transmission devices. The performance of these devices is impacted by how intimately the transmission coils are arranged with respect to the magnetic core material (e.g., ferrite). The system and method allows the printing of transmission coils directly onto magnetic core material, resulting in improved coupling as compared to non-printed implementations. Furthermore, because the system and method is not required to utilize Litz wire (which contains multiple layers of low thermal conductivity insulation), heat may be more efficiently removed from the transmission coil, allowing higher operating current density.

As part of enabling high performance wireless power transmission devices, the system and method provide the potential benefit of construction of high precision devices. That is, the system and method may enable the wire deposition with high precision (e.g., a 20 micron precision), such that identical devices created by implementation of the system and method will be identical to approximately some placement threshold (e.g., 20 microns).

This high precision may be particularly noticeable for large electromagnetic structure constructs. The system and method further provide the potential benefit of construction of devices that may achieve a tolerance of less than 1% in inductance at 3Σ.

The system and method may also enable the low-cost manufacturing of wireless power devices, particularly those with large planform area and/or conductor cross sectional area. Manufacturing cycle times and material scrap rates may be reduced relative to methods relying on etching processes.

The system and method may additionally provide the benefits of PCB transformers while reducing their drawbacks. Like PCB transformers, the proposed transformers may have precise geometric control and tight integration with converter electronics, but they may also have significantly higher copper fill fraction for efficient high frequency operation.

The system and method may enable winding topologies previously impossible to realize with either existing approach. For example, multi-dimensional interleaving, which offers significant potential for performance improvement.

Additionally, planar transformer technology has been around for more than fifty years yet novel approaches to reducing loss mechanisms are still being uncovered. The system and method may leverage this research, as well as add new techniques made possible by the additive platform, algorithmic implementation, and simulation-based design.

The system and method may also provide the benefits of additive manufacturing. Additive manufacturing may enable tighter integration between windings, core materials, and drive electronics.

The system and method may also provide improved wire layering techniques. Using the wire laying technique provided by the system and method, windings and core need not remain isolated components, but can be blended and produced in a single process. Blending the winding and cores means lower peak magnetomotive forces in the winding window, and can therefore significantly reduce high frequency core losses by minimizing flux density in the core.

The system and method may also provide the benefit enabling easy wire insulation stripping for making electrical terminations. Typically, wire stripping is a difficult task wherein current industry uses expensive UV lasers specialized for the task, with mixed results. The system and method may be implemented for a more improved sire stripping utilization.

### 2. System

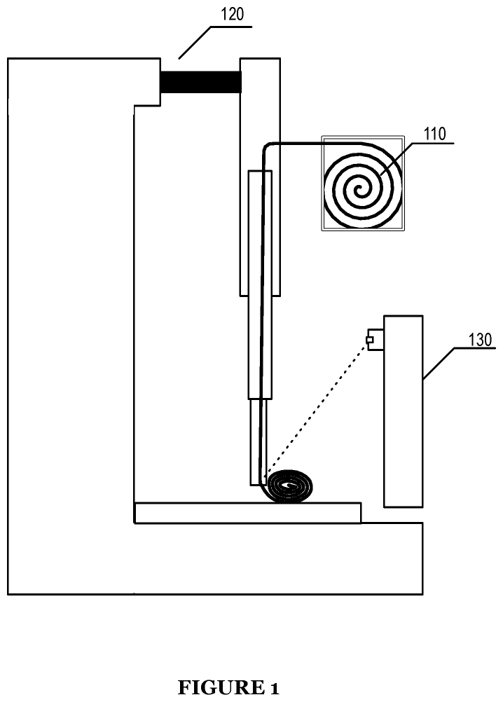

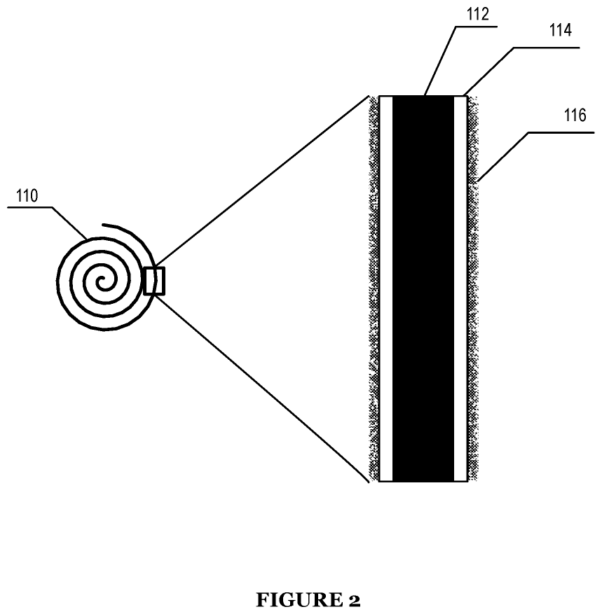

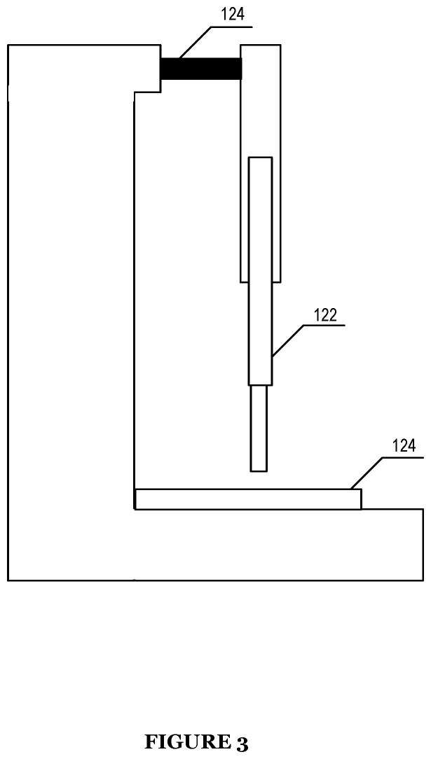

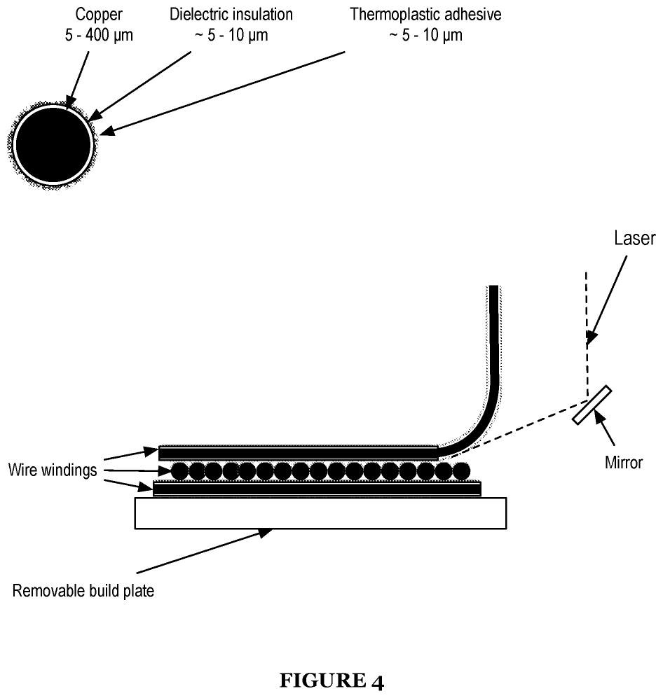

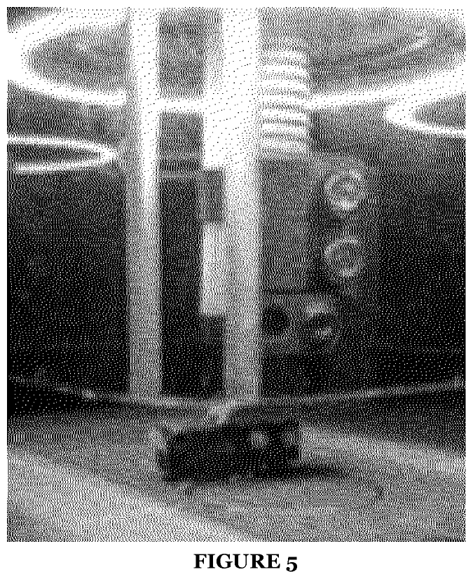

As shown in FIG. 1, a system for an additive platform for a wire-wound power transmission construct includes: a wire 110, comprising an interior metal core 112, an insulation coating 114, and an adhesive coating 116; a wire plotting platform 120, that shapes and deposits the wire in a moving region of wire deposition and a bonding module 130, comprising components that fix the wire into place. The wire 110, as shown in FIG. 2, may comprise an interior metal core 112 and an adhesive coating 116. Dependent on implementation, the wire 110 may further include an insulating coating 114 situated along the exterior of the metal core 112. The wire plotting platform 120, as shown in FIG. 3, may comprise a wire deposition component 122 and a positioning component 124 that includes an actuation system with at least two degrees of freedom. The bonding module 130 may comprise a mechanism that activates the adhesive coating 116, such that the wire anneals to itself, or to other components, in the region of wire deposition concurrent to deposition of the wire by the wire plotting platform. The system functions as a high-speed high-precision additive manufacturing device, wherein the device is suited for the construction of wire-wound power transmission devices. The system may be particularly suited for construction of wire-wound transformers with complex geometries (e.g., Litz wire windings) wherein, in this implementation the bonding module 130 may comprise a laser deposition tool. FIG. 4 shows one example schematic with a laser, bonding module 130 and FIG. 5 shows one picture of a prototype of this example. The system may additionally be implemented to build other wire-wound constructs (e.g., an inductor), other wire constructs, and/or make wire modifications (e.g., create etchings along a wire).

As an additive manufacturing device, the system functions in continuously depositing and fixing wire in a predetermined arrangement dependent on the desired implementation. As used herein, a region of wire deposition, is used to refer to the location that wire is deposited from the system. Thus, the region of wire deposition refers to an implementation dependent moving region at, or near, the point wire is manipulated and deposited from the system in the desired manner.

The wire 110 preferably functions as the construction base material of the system. The wire 110 may comprise a metal core 112 and at least one additional coating, i.e., an adhesive coating 116. In many variations, as shown in FIG. 2, the wire no may additionally include an insulation coating, such that the wire comprises an interior metal core 112, an insulation coating 114, surrounding the inter metal core, and an exterior adhesive coating 116. Dependent on implementation the wire may include other coatings. Examples of other coatings include: a protective coating, a padded coating, reflective coating, etc.

In some variations, the wire no may originally comprise just the metal core 112. In these variations, the system may additionally include a wire processing component, wherein the wire processing component adds additional coatings (e.g., insulation coating 114, and adhesive coating 116) to the wire no.

Dependent on implementation, the thickness of the wire 110 may vary. The system may enable implementation of wires that vary several orders of magnitude in thickness (e.g., ˜1-100 μm). One example of the wire 110 size variation is shown in FIG. 4, wherein the wire thickness varies 25 μm to 220 μm. Generally, the wire thickness is only limited by the potential to bend the wire (i.e., cannot be too thick to bend), and the wire integrity (i.e., must be sufficiently thick to not break). Thus, the wire thickness may be implementation specific and particularly dependent on the wire material and the desired build geometry. For example, in one “thin” wire implementation, the wire 110 may have a thickness of 25 μm (e.g., with a metal core of 10 μm, an adhesive coating of 5 μm and an insulation coating of 10 μm). In another “thicker” wire implementation, the wire 110 may have a thickness of 550 μm (e.g., with a metal core of 500 μm, an adhesive coating of 25 μm and an insulation coating of 25 μm). Generally, the wire may comprise any gauge wire that may be at least semi-malleable.

The wire 110 may include a metal core 112. The metal core 112 functions as the primary building block portion of the wire, which may, or may not, have additional properties. For example, as part of a transformer construct, the metal core 112 may function as conducting portion of the wire, enabling function. Dependent on the implementation, particularly the metal core composition, the metal core may vary from a 1 μm to a 500 μm thickness.

Although referred to as “metal”, the metal core is only metallic in some preferred variations. As required by implementation, the material construction of the metal core 112 may be limited by only one constraint: malleability. Other constraints may be incorporated by implementation, such as conductivity of the metal core 112. That is, the metal core 112 must be composed of a material that is sufficiently conductive for functionality at operating conditions (e.g., temperature, pressure, enclosure insulation, etc.). Also, the metal core 112 must be sufficiently malleable such that the wire 110 may be shaped as required by implementation.

The specific material type of the metal core 112 may be also dependent on implementation with the constraints described above. Examples of the metal core include: single metal (e.g., copper, Tungsten, silver, gold, aluminum, zinc, nickel), metallic compounds (e.g., iron oxide), ceramics (e.g., rhenium oxide), alloys (e.g., nickel 200, cupro nickel), ferromagnetic materials (e.g., iron, cobalt, nickel, rare-earth metals), etc.

In some variations, the metal core 112 may be magnetic, or ferromagnetic. Examples of magnetic metal core materials include: nickel, iron, cobalt, and gadolinium. In some magnetic variations, the metal core may comprise a magnetically soft material. Alternatively, the metal core may comprise a magnetically hard material. Soft magnetic materials are commonly used in electromagnetic cores, with material properties that may be carefully tailored to the application. In many variations, composite cores are used, such that more decoupling of permeability and resistivity is available. These magnetic metal cores 112 may require high temperature sintering, often with high pressures as well; which may be accomplished by the wire processing component. Alternatively, the processed wire may be acquired. Ferromagnetic wire, when coated with an insulator, can be considered a composite core system. In some variations, this composite core system does not require sintering. Alternatively, the composite core system may be produced using laser deposition (e.g., as part of the bonding module).

In one example, the soft magnetic metal core 112 may comprise nickel, or a nickel alloy (e.g., cupro nickel, or nickel iron, mu-metal). The soft magnetic metal core 112 may not be too brittle or ductile. Nickel alloy wire may have many desired magnetic properties. For example, nickel may enable relaxing constraints on resistivity and saturation, flux density. Additionally or alternatively, higher permeability magnetic materials may be used, which can boost device efficiency. In one implementation, where the metal core 112 is mu-metal. Mu-metal is strongly modified (i.e., activated) by a heated state, where the permeability significantly changes. A heating implement (e.g., a laser bonding module 130) may be implemented to activate the mu-metal.

In some variations, the wire 110 may include an insulation coating 114. The insulation coating 114 functions as an insulation layer surrounding the metal core 112. As an insulation layer 114, the insulation coating may electrically isolate the metal (e.g., a dielectric coating). The insulation layer 114 may additionally or alternatively provide thermal insulation, and/or other types of insulation (e.g., electrochemical). The insulation coating may vary typically from a 10 μm-20 μm thickness. Dependent on implementation, the insulation coating may be thinner or thicker than the typical range.

The wire 110 may include an adhesive coating 116. The adhesive coating functions to adhere the wire 110 to itself (e.g., during application of wire windings), or to other components (e.g., as part of some assembly). The wire may be composed of any desired adhesive. In preferred variations, the adhesive may be activatable (e.g., with heat, exposure to air, with electric current, pressure, solvent bonding etc.). The adhesive coating may typically vary from 5 μm-25 μm thickness. Dependent on implementation, particularly type of adhesive coating, the adhesive coating may be thinner or thicker than the typical range. In some variations the wire 110 does not include an adhesive coating 116. In these variations the adhesive coating 116 may be added/applied by the system (e.g., by the wire processing component).

In one variation, the adhesive coating 116 is thermally activated (e.g., heated or cooled). For example, the adhesive coating 116 may comprise a thermoplastic adhesive. Once the wire 110 is heated, the adhesive coating 116 is activated such that it may anneal to a desired surface, to another wire, to itself (e.g., another wire segment of the same wire), and/or to any other component desired by implementation.

In thermoplastic adhesive coating variations, the wire 110 may additionally have a dielectric insulation coating. This thermoplastic coating is often called “bondcoat”, and is commonly polyvinyl butyrol, though epoxy, polyimide, and polyester are also used.

In another variation, the adhesive coating 116 is a solvent bonded coating. That is, the adhesive coating 116, treated with a solvent, may become activated such that it may adhere to a desired surface or to another wire, or wire segment. In these variations, the system may include a solvent bed region, wherein solvent may be injected to, and drained, from the solvent bed region. The bonding module 130 may also include an applicator (e.g., solvent injection system, or solvent bed connected to a wire applicator) that applies a solvent to the wire as it is printed.

In another variation, the adhesive coating 116 may comprise a pressure activated coating. That is, the adhesive coating, placed under pressure (e.g., from a clamp, or laser focused light pressure), may become activated such that it may adhere to a desired surface or to another wire, or wire segment.

Generally, the adhesive coating 116 may comprise a single type of adhesive coating (e.g., thermoplastic adhesive), but may additionally include variations of multiple adhesive coatings 116. Multiple coatings may be used to have different adhesion strengths, and/or enable adhesion of the wire 110 to other components that may not adhere as well using a single type of adhesive coating 116.

The wire plotting platform 120, functions as the general build scaffold of the system comprising the required manufacturing components. The wire plotting platform 120 thus includes wire deposition components 122 and wire positioning components 124 in addition to a build platform for construction. The wire plotting platform 120, and the wire plotting platform components, may vary dependent on implementation. In addition to the wire deposition components 122, the wire positioning components 124, and a base platform, the wire plotting platform 120 may include many other components that provide general, or specialized tools for wire plotting. Examples of wire plotting platform 120 components may include: plotting head, wire guides, wire feeders, cameras, and sensors (e.g., for positioning, temperature, and pressure), post-processing tools (e.g., heating bed to remove all adhesive to remove excess adhesive, solution bath), cutting tools (e.g., to create multi-filament structures), a wire processing component (e.g., to apply select coatings to the wire 110), etc.

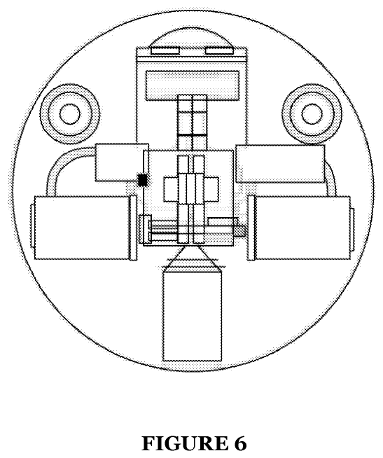

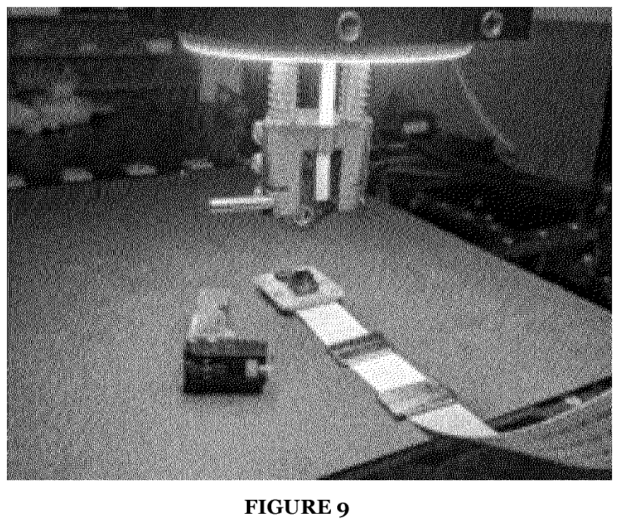

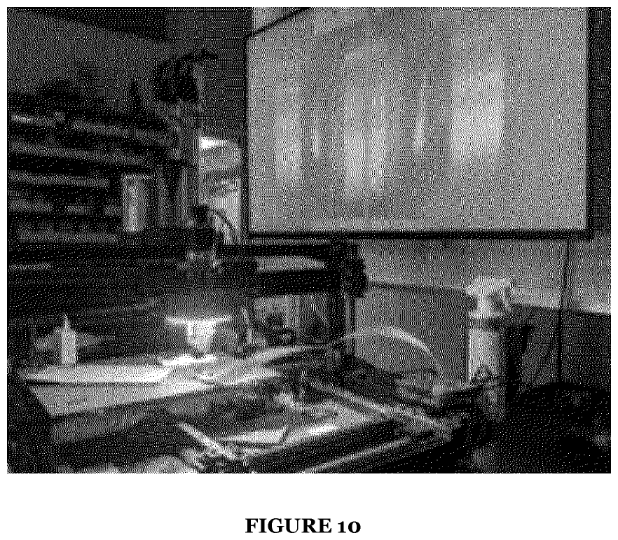

The wire plotting platform 120 may include a plotting head (also referred to as wire applicator). The plotting head functions to position and lay out the wire 110 as desired for a specific wire plotting in the region of wire deposition. One example set of schematics for the plotting head is shown in FIGS. 6-8, and one plotting head prototype is shown in FIGS. 9 and 10.

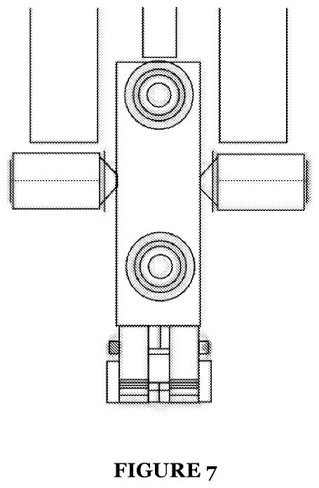

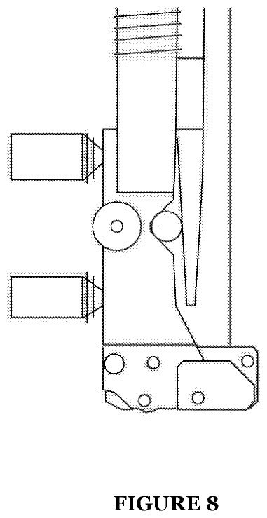

The plotting head may have an applicator tip. The applicator tip may function to “release” the wire in the appropriate position for an assembly. In one variation, the applicator tip is designed on an adjustable kinematic coupling. This coupling may make use of precision adjustment screws. In one example four precision adjustment screws are arranged in two opposing pairs (one for left-right adjustment, one for forward-backward adjustment), as shown in FIG. 6, a bottom view of the plotting head. As shown in FIG. 7, a rear-view schematic of the plotting head, one set of opposing pairs of screws may enable left-right adjustment. As shown in FIG. 8, a side view schematic of the plotting head, the second set of opposing pairs may enable forward-backward adjustment with a dowel pivot. The applicator tip is retained on the rotational axis by a “V”-groove on a steel dowel pin. The left-right adjustment screws translate the head along this dowel pin. The forward-backward adjustment screws pivot the applicator head around this dowel pin.

The plotting head may have an applicator roller. The applicator roller may function to “roll” out the wire at the desired rate through the applicator tip.

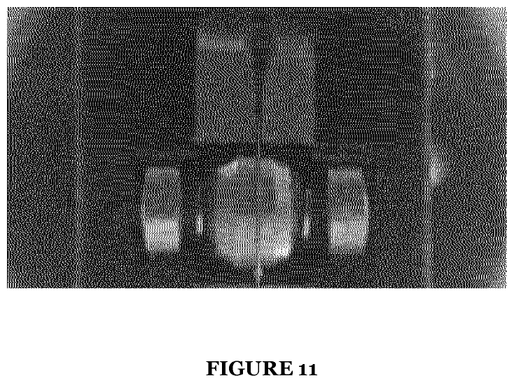

The plotting head may have wire guides (i.e., guides). The guides function to help position the wire 110. The spacing of the guides may change per implementation and/or use, and may be dependent on the wire thickness. The spacing of the guides may be set using precision shim washers, controlled to be larger than the diameter of the wire 110. In one variation, the guides spacing is set such that the guide spacing is approximately 20-30 microns larger than the wire diameter. In one implementation example for 90 micron wire 110 (e.g., 40 AWG metal core 112 and ˜10 m insulation coating 114), the guides may be set approximately 110-120 microns apart. One example prototype is shown in FIG. 11, of the underside of the applicator roller and its bearings, an 80 micron wire is passed between guides.

The wire plotting platform 120 may include a feeding mechanism. The feeding mechanism functions to draw the wire no and feed it to the plotting head. In one variation, the feeding mechanism comprises a motor and series of elastic strings that push the wire 110 to, and through, the plotting head. Alternatively, the feeding mechanism may pull the wire 110 to the plotting head. Inclusion and use of the feeding mechanism may be application specific. That is wires of higher gauge may require use of a feeding mechanism while lower gauge wires may not. Thus, the feeding mechanism may have an engagement apparatus: where once engaged, the feeding mechanism pushes the wire 110 through the plotting head; and once disengaged, the wire may pass through, or by, the feeding mechanism without aid of the feeding mechanism. Dependent on implementation, the wire feeder may be incorporated in, or on, the plotting head. Alternatively, the feeding mechanism may be situated on, or near, a wire housing (where the wire 110 is stored).

The wire plotting platform 120 may include a build platform (or plate). The build plate functions as a base surface to make the build assembly. Dependent on the implementation, the build plate may be of any size and/or shape. In some variations the build plate may be removed and/or replaced with different build plates depending on use. The build plate may also have actuating components, such that the build plate may be moved and/or repositioned during an assembly. In one variation, the build plate may have a single actuating component enabling actuation of the build plate vertically. In another variation, the build plate is movable in two dimensions. For example, the system may include at least two actuator systems configured for actuating the build plate in a horizontal and/or vertical dimension. In other variations, the build plate may be translated and/or rotated in other dimensions. Additionally or alternatively, the plotting head may be actuatable with one or more degrees of freedom.

In some variations, the build plate may comprise an exchangeable platform that may be added, removed, or changed dependent on implementation. For example, this may enable exchanging a “smooth” build plate for a “jagged” build plate, to enable the wire 110 to affix itself to the base platform during operation. Examples of different types of build plates may include: different surface type build plates (e.g., smooth, rough), build plate shape (e.g., flat, curved), build plate size (e.g., small, large), build plate with processing components (e.g., heat bed, fluid holding, magnetic field).

In some variations, the build plate may include a heat bed. The heat bed may have multiple functionalities dependent on implementation. In variations where the wire 110 includes heat bonding components (e.g., a thermally activated adhesive coating 116), the heat bed may be used to control the temperature of the substrate and previously laid wires 110. This limits the amount of heating the laser must perform on the wire as it is laid, and increases the achievable feed rates. Further, this consistent temperature (usually ˜90 C for polybutyrol bondcoat) increases reliability of the wire bonding. The elevated bed temperature can also aid in cleanly releasing the printed component from the substrate after printing and allowing the system to cool. The heat bed may also be used to remove residue adhesive material. By general heating of the wire 110, the heat bed may activate/remove all remaining adhesive material from the wire such that the wire does not accidentally adhere to other things at some later time. In variations where the wire is an activatable ferromagnet (e.g., mu-metal). The heating bed may be implemented to activate the properties of the ferromagnetic.

The heat bed may comprise resistor circuitry embedded in the base plate, such that once turned on activated, the build plate surface heats up to a desired temperature. In this manner, the heat bed may encompass one surface region of the build plate, or the entire surface of the build plate. For example, in one implementation, one corner of the build plate comprises the heat bed. Once some wire construct is completed (or portion thereof completed), the wire construct may be moved to the heat bed region of the build plate for post-processing.

In some variations, the build plate may include a solvent bath. The solvent bath may be used for post-processing of any wire construct in a similar manner as the heat bed. For example, the solvent bath may be used to remove adhesive for solvent adhesive variations.

In some variations, the build plate may include a field emitter (e.g., magnetic field). field emitter may function to emit an electromagnetic field during or after wire deposition. Use of a field emitter may be particularly suited for magnetic wire 110 implementations. For example, the during wire deposition, the field emitter may emit a magnetic field in the region of wire deposition to align the wire polarity, thereby aiding a more precise positioning and annealing of the wire 110. In post processing implementations, the field emitter may aid in magnetizing the wire construct with a desired magnetization and polarity.

The system may include a bonding module 130. The bonding module 130 functions to aid in fixing/annealing/adhering/locking the wire 110 in a fixed position as part of the construct. The type and precise function of the bonding module 130 may be highly dependent on the adhesive coating 116 of the wire 110. In variations where the adhesive coating 116 is thermally dependent (e.g., a thermoplastic), the bonding module 130 may comprise a laser-assisted bonding module, wherein a laser is used to activate the adhesive coating for localized precision bonding. That is, the bonding module 130 may comprise a laser module directed at the region of wire deposition, enabled to heat the wire, locally activating the thermally activatable adhesive coating 116, such that the wire anneals to itself or to other components in the region of deposition. Alternatively, the bonding module 130 may comprise a hot air module, wherein heated air is directed to regions of the wire for localized precision bonding. Alternatively, the bonding module 130 may comprise an ultrasonic emitter (e.g., an ultrasonic transducer), wherein ultrasonic radiation is directed to regions of the wire for localized precision bonding.

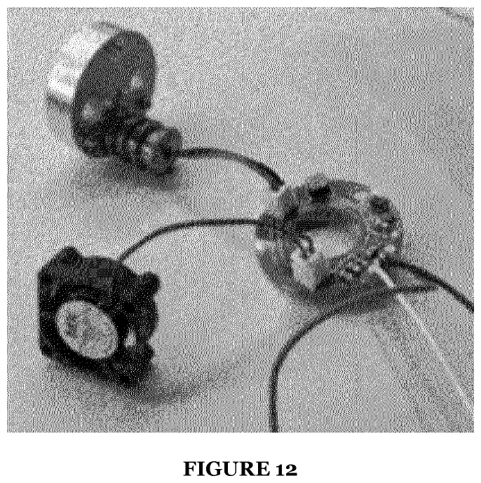

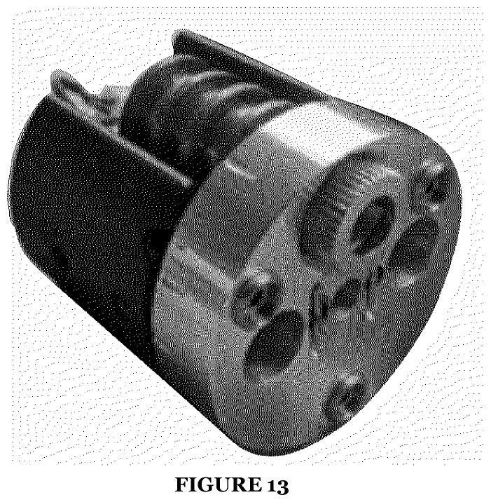

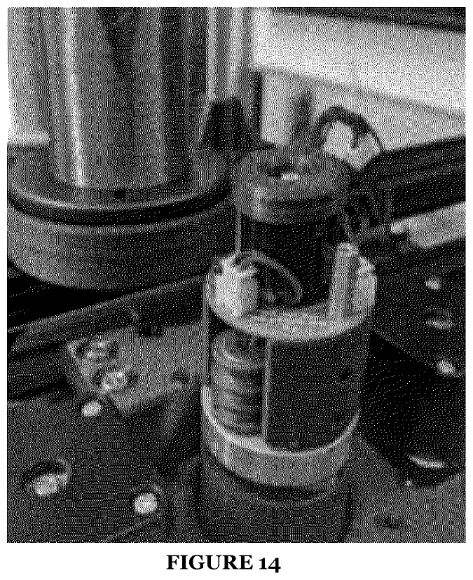

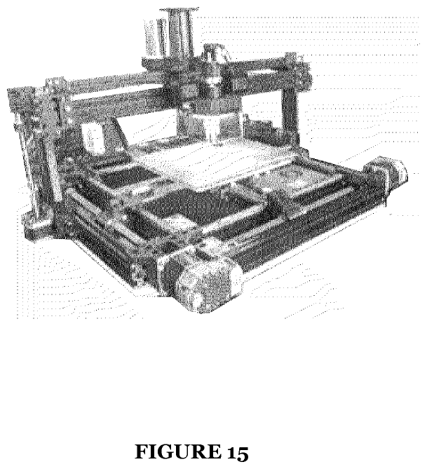

In one variation for a laser bonding module 130, a laser diode may be installed in a copper heat sink over which air is forced by a fan. The laser power is modulated by a buck converter, to control the optical power output. In one case, a 405 nm diode is implemented, capable of outputting approximately 900 mW of power while remaining within safe operating limits. FIGS. 12-14 show a sample laser prototype. As shown in FIG. 12, the laser bonding module components may include: laser, heat sink, fan, and adjustable buck converter. FIG. 13 further shows the components assembled with an adjustable kinematic coupling; FIG. 14 shows the components on a rotational axis of the wire plotting platform 120. FIG. 15 shows a sample system with the laser bonding module with safety components installed.

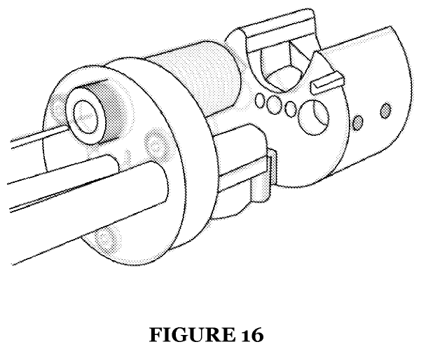

To guide the laser through the narrow guide channel, a precision, adjustable kinematic coupling may be used at the laser module. The kinematic coupling may be arranged so uniform thermal expansion would only translate into a change in the laser pitch, not in the laser yaw. This kinematic coupling is shown in FIG. 16. In one example, the laser module may be mounted on an aluminum plate, which is retained against the upper tool head by a pair of springs. This spring force may cause the ball bearing ends of three fine-adjustment screws (in this case 3/16-100 size) to locate in three corresponding v-grooves in the upper plot head, in the manner of a classic kinematic coupling. By adjusting the screws, the laser beam may be fined tuned to a high level of accuracy.

The laser bonding module 130 may include a heat sink to dissipate heat. Dependent on implementation, heat dissipation may enable heat dissipation both in proximity to the laser and in proximity of the wire construct. The heat sink may be preferably designed to draw heat away from the kinematic coupling, and hence avoid thermally-induced alignment errors. In one variation a copper heat sink is used.

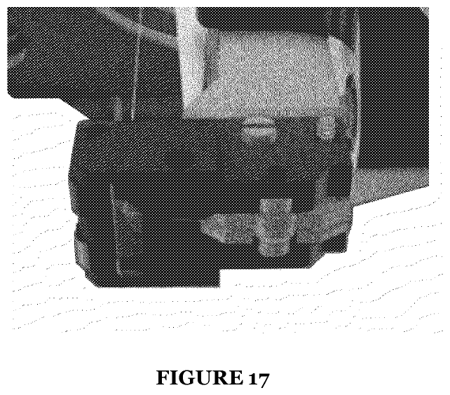

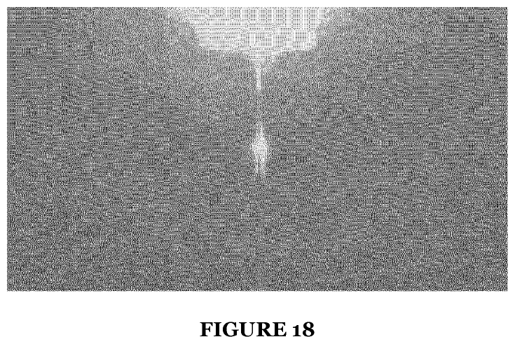

In laser variations, the bonding module 130 may include a mirror (or other device that can redirect a light, such as prism). The mirror may function to redirect the laser close to the point of wire application. As shown in FIG. 17, the mirror may be located in the plotting head to direct the laser as close as possible to the point of wire application; wherein the shows the path of the laser down from the module reflected off the mirror and through the wire guides. Positioning the mirror on the plotting head may additionally ease focal length requirements to be satisfied and enable easier integration of a cooling system with the laser. As an addition to FIG. 11, FIG. 18 shows the same view with the laser turned on; showing the beam hitting the wire just as it leaves the guides and before passing over the roller.

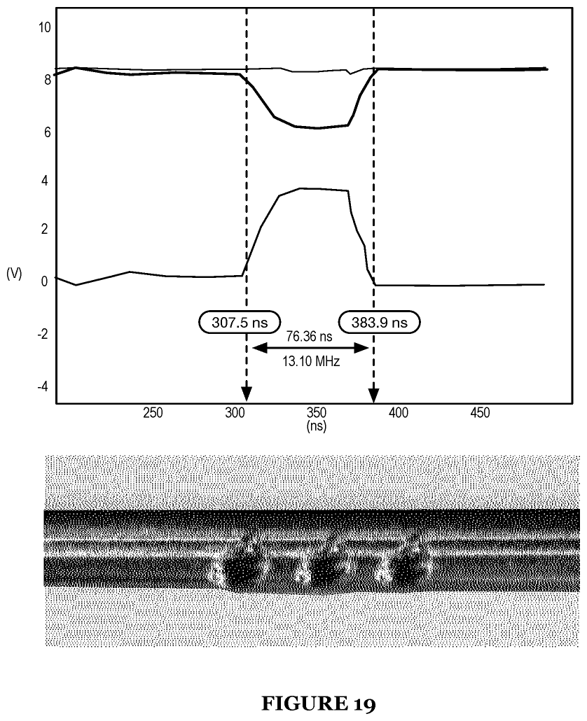

The laser bonding module 130 may also have additional wire manipulation functionalities. Through focus of the laser onto the wire 110, modifications can be made on the wire and/or the wire surface. For example, etchings may be made into the wire that include removal of coating layers (e.g., insulation layer 114). As part of wire modification, etchings may even be made on the metal core 112, thereby making a region of the wire 110 thinner, or even enabling severing the wire in desired locations. In this manner, the laser bonding module 130 may be used to etch, strip, and/or cut the wire 110 as desired. FIG. 19 shows one sample wire with etchings.

In some variations, the system may include a control module. The control module may communicate with the different system components and modify and/or control each component simultaneously or individually. The control module may comprise a processing device with communication channels to other components. The control module may enable: user control of the system, wherein the user may dictate how each component functions; guided user control of the system, wherein the user sets certain system parameters and/or controls some system components and the control module modifies the functionality of other components in conjunction with the user; and fully automated control, wherein the control module dictates and/or modifies system components from a set of designated parameters or implementation request).

Communication may occur over direct wire connection or wireless connection. Any general communication protocol (e.g., 802.11, Bluetooth, telnet, etc.) may be implemented with the system.

The control module may further function to enable complex winding constructs. That is, the control module may include a configuration to control the wire plotting platform 120 to deposit one, or multiple, wires 110 in complex winding patterns. In one variation, the control module is configured to control the wire plotting platform 120 to deposit the wire 110 in a 2D winding pattern. In another variation, the control module is configured to control wire plotting platform 120 to deposit the wire 110 in a 3D winding pattern. In one example, the control module is configured to integrate the actuation of the applicator head of the wire plotting platform 120 that deposits the wire 110 in a 2D winding pattern concurrent to a third degree of freedom provided by actuation of the base platform, thereby enabling construction of a 3D winding pattern.

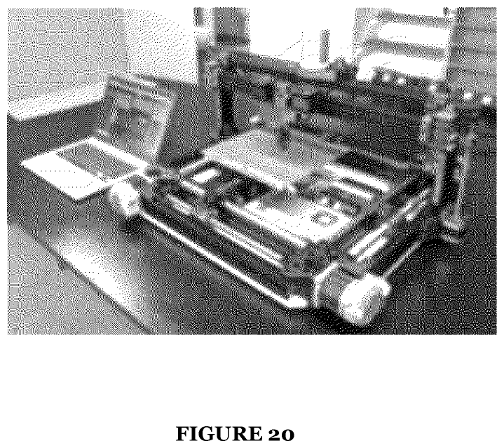

FIG. 20 shows a prototype of an example system as described above. This system comprises a wire plotting platform 120, including a moving heating bed, a plotting head with vertical and rotary axis of actuation. The wire 110 comprises a supply of 80 μm insulated copper wire, shown sitting on top wire plotting platform 120.

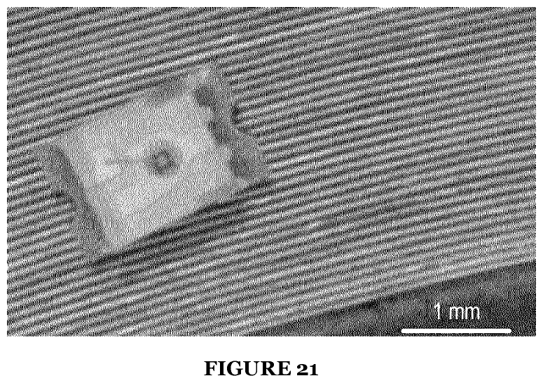

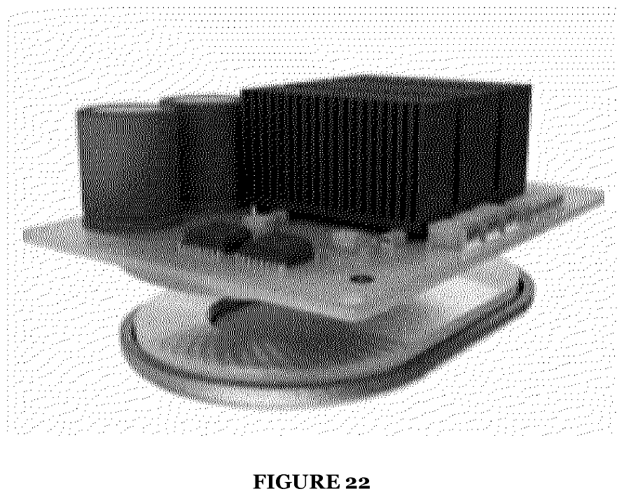

A multi-dimensional multifilar interleaving transformer may be a construct of the additive platform system as described above. In many variations, this multifilar interleaving transformer may be a wireless power transformer. Two examples of multi-dimensional interleaving transformers are shown in FIGS. 21 and 22 that may be a product of construct of the additive platform system. Stacking in multiple dimensions may be used in forming unique wire interleaving patterns. The multi-dimensional interleaving transformer may leverage the additive manufacturing techniques described below in producing unique transformer designs. The interleaving wire winding patterns used in the design of the transformer may additionally or alternatively be applied in the design of other electronic components such as inductors, wireless chargers, antennas, motor windings, and/or other components that include patterned weaving and/or coiling of wires. The interleaving transformer may comprise a “composite core” system. The transformer may be a metal core wire wound transformer, wherein the winding may have zero, one, two, or several interleavings. These interleavings can be stacked—arranged in multiple dimensions in the cross-sectional area of the windings. The interleaving transformer may use a variety of wire interleaving patterns, as described herein. The various wire interleaving patterns may be used in various combinations.

The wire 110 used in the windings of the transformer may include any of the variations of the wire described above. In one variation, the resulting transformer comprises a wire wound in a two-dimensional bundle, where wires are arranged within a cross sectional area in a horizontal and a vertical dimension. For at least a portion of the wires, a wire segment includes an outer coating that is fixed (or adhered) to the outer coating of an adjacent wire segment. More specifically, a wire segment may include a thermoplastic adhesive coating 116 that is fixed to a thermoplastic adhesive coating of one or more adjacent wire segments. This can be achieved using the laser-enhanced additive wire plotting process described above. The fixed or adhered outer coating can be used to stack wires in a desired pattern with high precision.

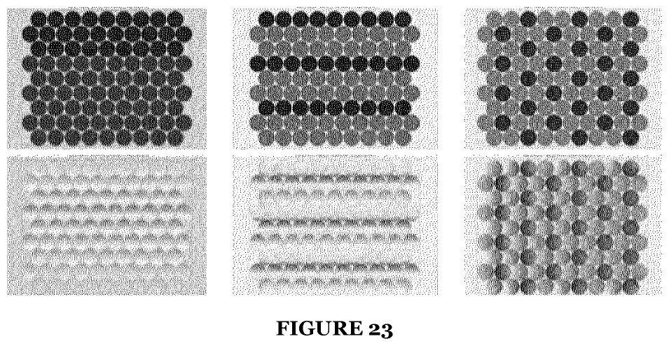

In a first variation, as shown in the second column of FIG. 23, a single interleaving pattern may be used, where an interleaving pattern can be repeated in a stacked “vertical” direction. Single interleaving may alternatively be performed in a “horizontal” pattern. In this example, a 2:1 transformer is shown with the black and white wires, but any suitable transformer ratio can be used.

In a second variation, as shown in the third column of FIG. 23, a double interleaving pattern may be used where an interleaving pattern can be performed in two dimensions where it is stacked vertically and offset horizontally. Various other winding patterns could additionally or alternatively be formed by grouping and/or otherwise arranging windings. The patterns may be tuned for different AC resistance ratios and/or other performance metrics. In this example, a 2:1 transformer is shown with the black and white wires, but any suitable transformer ratio can be used.

In another variation, the transformer can comprise a wire that includes a magnetic core, which can be used within the multi-dimensional windings. This may be used for integrating the core into the windings. Alternatively, magnetic core wires may be integrated in a pattern of other windings. As shown in the first column of FIG. 23, a single interleaving pattern may be used with magnetic core windings being used to separate layers in one dimension. As shown in the second column of FIG. 23, a double interleaving pattern may be used with magnetic core windings separating other windings in two dimensions. In FIG. 23 the soft magnetic core is shown in gray, primary windings shown in white, and secondary winding shown in black. These examples reflect a 2:1 transformer winding but any suitable transformer ratio could be made.

The integration between windings, core material, and drive electronics may be achieved through the additive manufacturing processes described herein. Applying the wire patterning techniques described herein, windings and core can be blended and produced in a single process. These blended core transformers may function to have lower peak magnetomotive forces in the winding window (as compared to non-blended transformers), which may significantly reduce high frequency core losses, by minimizing flux density in the core.

Other patterns may additionally or alternatively be used. Herein, the patterns are described for a particular cross section. This pattern may be used substantially continuously along a coil of wires. The pattern may alternatively change at different regions of a coil. For example, one interleaving pattern at a first defined cross sectional area may transition to a second interleaving pattern at a second defined cross-sectional area.

The transformer may additionally include etched contacts on the wires. The etched contacts may remove portions of the coating of the wire. The laser-enhanced process described herein may be used to expose conductive contact to the wires at select regions. In some variations, two or more etched contact regions of the wire may be positioned to enable conductive contact between two adjacent segments of wire.

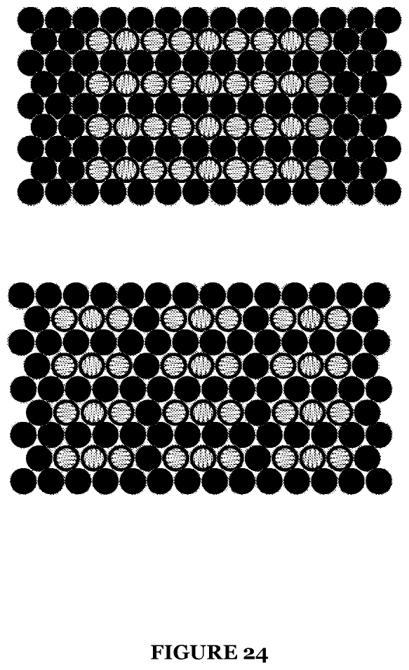

In two other example variations, as shown in FIG. 24, the multi-dimensional interleaving transformer may comprise a composite/blended core bifilar winding transformer. The core (shown in black) may comprise a magnetic core (e.g., mu-metal) that is in proximity to a primary winding (shown with a horizontal squiggle) and a secondary winding (shown with a vertical squiggle).

As mentioned above, the multi-dimensional interleaving transformer may comprise any general multi-filar form with any desired interleaving pattern, usable for transformers and/or any other desired wire-wound device (e.g., the metal core of the wire may be a composite metal, magnetic core, and/or any other “metallic” type core limited only by the malleability of the composition.

### 3. Method

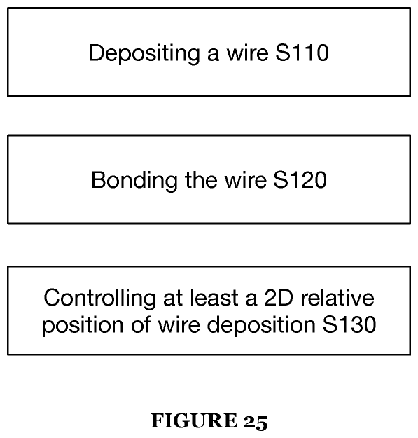

As shown in FIG. 25, a method for producing a multifilar wire composition using laser aided deposition comprises: through a plotting device, depositing a wire S110, comprising driving the wire through a plotting device, wherein the wire has an outer adhesive coating; bonding the wire S120, thereby activating the outer adhesive coating of the wire in a localized region of deposition; and controlling at least a 2D relative position of wire deposition S130 relative to a deposition plate. The method functions to create high-precision, multifilar, wire-wound constructs (e.g., transformers and inductors) with complex geometries using an additive machine.

As this method may be very dependent on desired implementation and incorporated system, the method may include other steps. In some variations, the method may further include a step for calibrating the system. Additionally, the method may further include steps for modifying the wire and wire construct, and/or post-processing of the wire and/or wire construct.

As wire printing may be a complex process, method steps may not necessarily follow a linear order. Dependent on implementation, steps may occur in any order, simultaneously, and/or steps may be skipped as necessary.

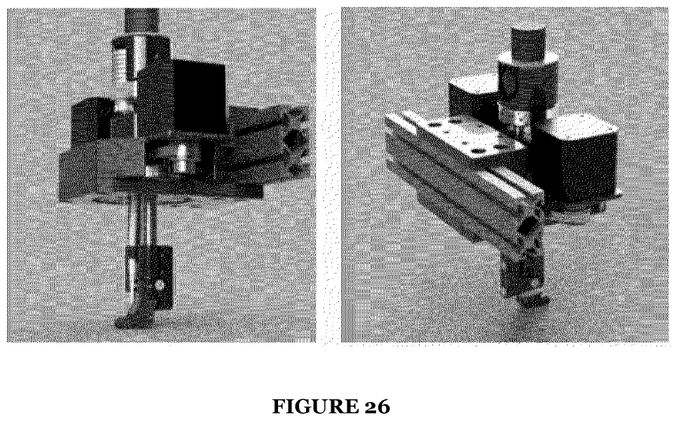

The method may be implemented with the system as described above, but may be generally implemented with any laser-assisted wire deposition system. FIG. 26, shows a sample system example of the laser-assisted printing process, where a wire applicator deposits a wire with thin thermoplastic adhesive coating, and a laser heats this coating just before deposition. This may allow multiple layers and overlapping windings of multiple wires to be built with few or no limitations. Herein, the method is presented, as applied to the laser-assisted printing module, as presented in the above example Presentation with focus on this specific system implementation bears no limitation on implementation of the method.

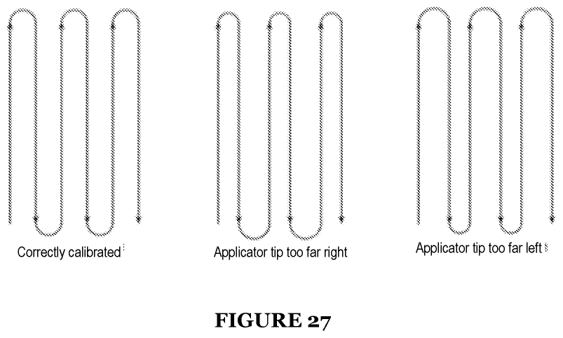

In some variations, the method may include calibrating the system functions to set the precision, and thus enable functionality of the implemented system. Calibrating the system may differ significantly, dependent on the implemented system. In some variations, the system may not require calibration, and thus calibrating the system is not performed (i.e., is not part of the method). To obtain accurate placement of wire during the printing process, the position of the applicator tip relative to the axis of rotation is critical. If not set correctly, the resulting wire geometry will not be as specified. One example of a calibration comparison is shown in FIG. 27. For instance, if the applicator tip is offset from the axis to the right (with reference to the forward direction of plotting), counterclockwise circles will be larger than specified, while clockwise circles will be smaller than specified. For dense packings of conductors, alignment in the placement of the conductors is critical.

Setting these adjustment screws to align the point of application with the rotational axis is performed with a calibration routine using optical feedback. In one instantiation, an upward facing camera is used to examine the applicator tip during rotation. After installing the applicator tip, the axis is rotated, and the stationary point observed through the camera. This stationary point necessarily lies on the rotation axis. The adjustment screws are turned until the stationary point lies on the wire as it passes over the middle of the applicator roller. This technique can accurately calibrate both axes of alignment.

In another variation, a downward facing camera may be used. A serpentine pattern of wire may be printed and measured with the downward facing camera, using the X-Y motion to measure the spacing of the consecutive wires (shown in FIG. 16). The screws are adjusted until the spacing is consistent. This technique is accurate for calibrating the left-right axis, but can be difficult to use to align the forward-backward direction. In practice, several serpentine patterns of progressively finer pitch may be used, as the errors in forward-backward misalignment are more pronounced for very small radii of curvature.

Block S110, which includes depositing a wire, functions to place one, or more, continuous strands of wire, in the appropriate location with the appropriate alignment dependent on the desired build. Depositing a wire S110 comprises driving the wire through a plotting device, wherein the wire has an outer adhesive coating. The wire may be guided down through a plotting head over application rollers, wherein positioning of the application would set both the positioning and orientation of the wire. Thus, depositing the wire S110 may include feeding the wire onto a substrate.

Feeding the wire may be dependent on system implementation. For low gauge wires, the actuating components of a system applicator mechanism (e.g., application roller) may be sufficient for depositing the wire (i.e., passive feeding). For higher gauge wires and/or more complex deposition systems, feeding the wire may comprise an additional motor (or other actuating system) that pushes, or pulls, the wire to the plotting head (i.e., active feeding).

In some variations, depositing the wire S110 may occur through an applicator that actuates vertically. This may occur in conjunction with actuating of the substrate, wherein the substrate may include an actuation mechanism. Actuation of the substrate may be either two-dimensional (e.g., movement of a platform) or three-dimensional. Alternatively, the applicator may actuate in a planar motion (e.g., horizontal plane) wherein the base substrate may actuate orthogonal to the planar motion (e.g., vertical actuation). In some variations, the applicator may additionally include rotational motion during depositing the wire S110, thereby enabling positioning and construction of coils and more complex wire geometries.

Block S120, which includes bonding the wire functions to fix the deposited wire in place. Bonding the wire S120, may thus activate the outer adhesive coating of the wire in a localized region, enabling the wire to adhere to something in this localized region. Bonding the wire S120 may affix the wire to itself (e.g., a distinct wire segment of the same wire), to another wire, and/or to a desired substrate. The method of bonding may be system dependent. For a laser heating thermoplastic wire adhesive system, bonding the wire S120 functions to locally heat the wire thereby activating a thermoplastic adhesive mechanism. As the wire is guided down over the applicator roller, a laser provides the energy required to soften and activate the adhesive, allowing the wire to stick down to the substrate, as well as to other wires.

Bonding the wire S120 may occur in conjunction with depositing the wire S110. That is, in some variations, bonding the wire S110 includes activating the laser such that a laser beam is directed onto the wire surface as it is deposited on the substrate. In variations where the wire has a thermoplastic adhesive coating, the laser beam may sufficiently heat the thermoplastic such that it adheres to a previously positioned wire, or other component(s). bonding the wire S120 may comprise directing the laser on the entire surface of the wire, such that the entire outer-surface/coating is “activated” to adhere. Additionally or alternatively, a more precisely directed heating approach may be implemented. As desired, in some regions of the wire, only an arc of the outer circumference is heated. This directed heating may enable more complex layering of the wire by enabling deposition of additional wire prior to adhesion of the wire.

To consistently apply optical power to the wire, the laser may be directed at the wire while it is adequately constrained (e.g., by guides). In one example, this may happen just prior to passing over the applicator roller when it passes between a set of stainless-steel guides. To guide the laser into and through the guide channel a precision, adjustable kinematic coupling may be used at the laser module.

The laser module may be mounted in an aluminum plate, which is retained against the upper toolhead by a pair of springs. This spring force causes the ball bearing ends of three fine-adjustment screws (in this case 3/16-100 size) to locate in three corresponding v-grooves in the upper plot head, in the manner of a classic kinematic coupling. By adjusting the screws, the laser beam may be pointing very accurately. The copper heatsinking is designed to draw heat away from the kinematic coupling, and hence avoid thermally-induced alignment errors.

As an added measure, the kinematic coupling may be arranged so uniform thermal expansion would only translate into a change in the laser pitch, not in the laser yaw. That way, any expansion does not affect the alignment of the beam with the wire guides, only with the (less sensitive) dimension perpendicular, which affects how near to the applicator roller the laser and wire meet. As the operating focal length is long enough that such errors are small by comparison, any focal errors due to this are negligible.

A heating bed may also be used to assist in bonding the wire S120. For heat activated adhesive variations, bonding the wire S120 may include: at a heating bed, heating the wire. The heated bed may be used to control the temperature of the substrate and previously laid wires. This may be in complement or as a replacement to heating the wire S120 with the laser component. bonding the wire S120 at a heating bed may limit the amount of heating the laser must perform on the wire as it is laid, and may increase the achievable feed rates. Furthermore, this consistent temperature (e.g., ˜90 C for polybutyrol bondcoat) increases reliability of the wire bonding. The elevated bed temperature can also aid in cleanly releasing the printed component from the substrate after printing and allowing the system to cool.

Dependent on implementation, bonding the wire S120 may include varying the heating temperature (i.e., varying the heating). Varying the heating may occur at either, or both, at the laser or heating bed. Varying the heating may function to enable use of different material (e.g., if the wiring and or wire coating has been changed), enable different levels of adhesion (e.g., partial adhesion of a wire to a substrate versus embedding the wire onto the substrate), and potentially enable a system to have additional functionalities (e.g., enable a system to have a wait period in the middle of wire deposition). For example, after an initial bonding the wire S120 step to fix the deposited wire, the heating may be reduced to enable localized segmented annealing of the wire (i.e., leave a gap where the wire is not fixed). This may then enable a separate wire (or a different segment of the same wire) to be threaded, or wound, through the segmented region.

Block S130, which includes controlling at least a 2D relative position of wire deposition functions, to enable the construction of multifilar complex weavings. Controlling at least a 2D relative position of wire deposition comprises controlling the axes of motion of the plotting head relative to a base plate where the wire is deposited. Through these two degrees of freedom the method enables construction of complex wire interweavings. Thus, dependent on implementation, controlling at least a 2D relative position of wire deposition comprises creating a wire interweaving. This may be done at high precision such that controlling at least a 2D relative position of wire deposition may comprise creating a Litz winding. In some variations, this wire deposition may incorporate depositing multiple wire strands, thereby forming multifilar interleaving coils. As desired by implementation, this may comprise creating multifilar Litz windings.

In some variations, the method may further include controlling a 3D relative position of wire. This may be implementation specific, wherein this may include 3D actuation of the applicator head. Alternatively, controlling a 3D relative position of the wire may comprise controlling a separate degree of actuation (e.g., movement of the base) relative to wire deposition.

In some variations that are incorporated with a laser system, the method may further include: modifying the wire, using the laser system. Modifying the wire may function to alter the structure, property, and/or shape of the wire during construction. By directing a laser on a region of the wire, that region may be modified dependent on the properties of the laser and the wire. Examples of modifying the include: shearing the wire (e.g., locally removing insulation), cutting the wire, sintering the wire, and activating magnetic properties (e.g., activating a ferromagnet by heating). Shearing or cutting the wire may enable additional complex wire winding structures, wherein forks and other connections may be introduced into the wire winding.

Controlling at least a 2D relative position of wire deposition S130 may be implemented with a high level of precision. This may be particularly true with laser system implementations. In some variations, the controlling at least a 2D relative position of wire deposition, comprises depositing the wire with a 20 micron precision, such that repeated implementations of the method to make the same wire construct will create identical constructs to approximately 20 microns. This high precision may be particularly noticeable for large electromagnetic structure constructs. Through controlling at least, a 2D relative position of wire deposition S130, may achieve a tolerance of less than 1% in inductance at 3Σ.

As an implementation of the method, the method may be used for laser-assisted wire stripping for making electrical terminations, in addition to heating the bond coat. Typically, laser machining such thin dielectric coatings with CO₂ (˜10 um wavelength), or fiber lasers (˜1 um wavelength) is difficult, because the coating is only a few times thicker than the laser wavelength and doesn't absorb well. Laser wire stripping is a developed industry, but for thin enamel coating (˜10 um or less), expensive UV lasers are often used (e.g., Excimer lasers, wavelength ˜200 nm). Such UV lasers can perform cold machining, which strips the insulation without excessive heating, leaving crisp edges and the surrounding insulation intact. As part of a system implementation, this effect may enable using an inexpensive and small UV diode laser (405 nm) in combination with pulsed nanosecond machining. The pulsed machining achieves some of the effect of the shorter wavelength and allows effective processing of thin dielectric layers. FIG. 19 shows the results of this, as three controlled regions of insulation have been stripped from an 80 um wire. The right shows a controlled current pulse sent to the laser of 75 ns, which was used for the machining. The current pulses must be controlled to avoid spikes which can damage the laser diode, but commodity integrated circuits are capable of this, and drivers utilizing high electron mobility transistors can push the bandwidth even further.

Dependent on implementation, the method may further include post-processing steps. Post-processing steps may function any number of ways to modify the already finished (or partially finished) wire construct as desired by implementation. Post-processing the wire may include: removing extraneous adhesive material, activating wire properties, coating the wire in a protective coating (e.g., rustproof coating), etc. In variations that are incorporated with the laser system, post-processing the wire may include any of the modifying the wire implementations (e.g., wire shearing, cutting, sintering, etc.)

As part of the heating bed implementation, heating the wire may further enable a level of post-processing of the wire. That is once the wire construct (or part of the wire construct) is completed, heating the wire may further heat the wire sufficiently such that the adhesive coating is completely activated and removed. As the wire construct (or section thereof) is completed, there is no need to further leave behind an adhesive coating that may potentially cause issues at some future time. Thus, post-processing the wire in this manner functions to “clean” the wire of extraneous adhesive material. In some variations, instead of the heating bed, heating the wire to remove extraneous adhesive material may include directing a broad focus on laser on the completed region of the wire.

Through the combination of depositing the wire S110, and bonding the wire S120, laser-assisted deposition may enable complex multidimensional windings and/or interleavings. An example interleaving is shown in FIG. 21 for high frequency transformers where adjacent wires have been used for illustrative purposes to represent the primary and secondary coils in a transformer. This level of interleaving significantly mitigates increased resistance at high frequencies due to skin and proximity effects. As shown in FIG. 22, a conceptual sketch of a power converter may make use of the wire printed transformer (exploded view shown on below it). The described wire printing platform may be used to extend this interleaving strategy even further, using two dimensions of interleaving.

As shown in FIG. 23, through the multi-dimensional interleaving techniques, a 2:1 transformer may be simulated; wherein six configurations are shown. The top row shows the current density distribution at 1 kHz (representative of DC behavior), while the bottom row shows the same for 1 MHz operation. The left column shows a conventional winding, with primary and secondary separate. The middle column shows a single-interleaving strategy, similar to that practiced with most PCB transformers. The right column shows a double-interleaving strategy made possible by the method described here. Because of proximity effects, the current distribution of the first two strategies changes considerably between DC and high frequency, inducing significant AC resistance. Only in the third strategy does the current distribution stay largely the same, due to the double interleaving.

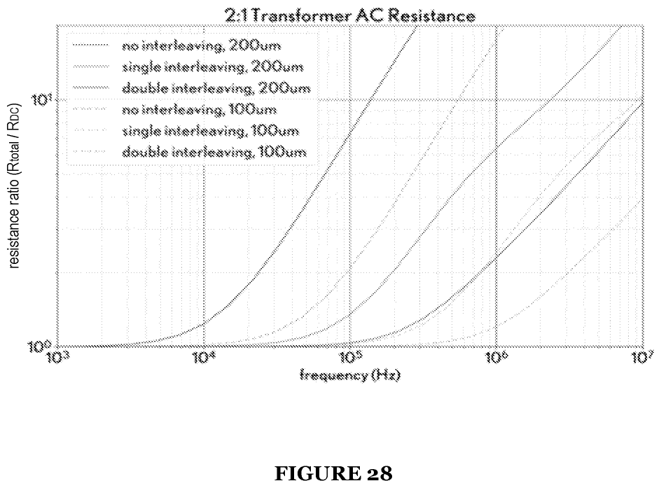

FIG. 28 shows the AC resistance ratio for these transformers, with solid curves representing 200 μm diameter wire, and dashed curves 100 μm wire. The double interleaving strategy may offer an order of magnitude reduction in AC resistance ratio, compared to a conventional winding. Reducing wire diameter offers an additional 2-3× reduction. As shown, the use of interleaving and of small diameter wire enabled by the AM platform offer significant potential for performance improvement.

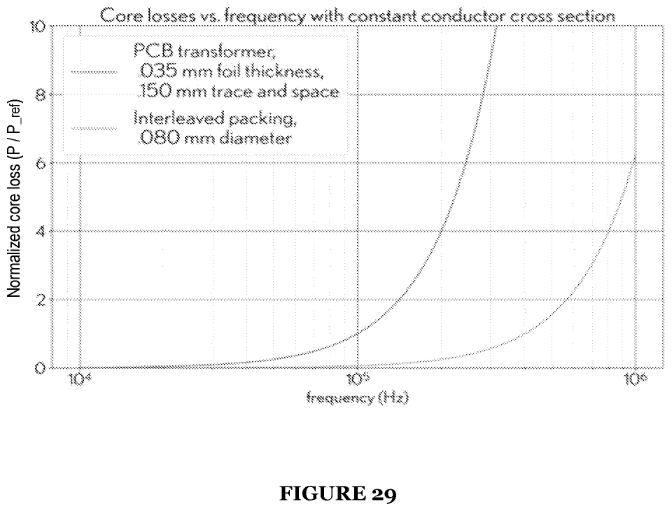

As shown in FIG. 29, comparing modeled PCB transformers with the proposed interleaved windings with the same conductor cross-section, using standard values for manufacturing constraints of PCB transformers and Steinmetz formulas. for core eddy and hysteresis losses, for an equivalent core loss; interleaved windings offer four times higher operating frequency due to better copper fill fraction and lower core flux density.

As shown in FIG. 24, the method may enable construction of a composite/blended core winding transformer. The core (shown in black) may comprise a magnetic core (e.g., ferromagnetic) that is in proximity to a primary winding (shown with a horizontal squiggle) and a secondary winding (shown with a vertical squiggle). As part of a method implementation, the composite core and windings may be constructed without requiring a sintering step, and may be produced in a single process.

### 4. System Architecture

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

In one variation, a system comprising of one or more computer-readable mediums storing instructions that, when executed by the one or more computer processors, cause a computing platform to perform operations comprising those of the system or method described herein such as: calibrating the system; depositing the wire; and bonding the wire. This may comprise the computing platform to direct a wire plotting platform and a bonding module through a first set of operations for calibrating the system. This may also comprise the computing platform to direct the wire plotting platform through a second set of operations for depositing the wire. This may also comprise the computing platform to direct wire the bonding module through a third set of operations for bonding the wire. The control of the wire plotting platform may be used to construct a transformer and/or other wire-based devices as described herein.

Similarly, in another variation, a non-transitory computer-readable medium storing instructions, that when executed by one or more computer processors of a communication platform, cause the communication platform to perform operations of the system or method described herein such as: calibrating the system; depositing the wire; and bonding the wire.

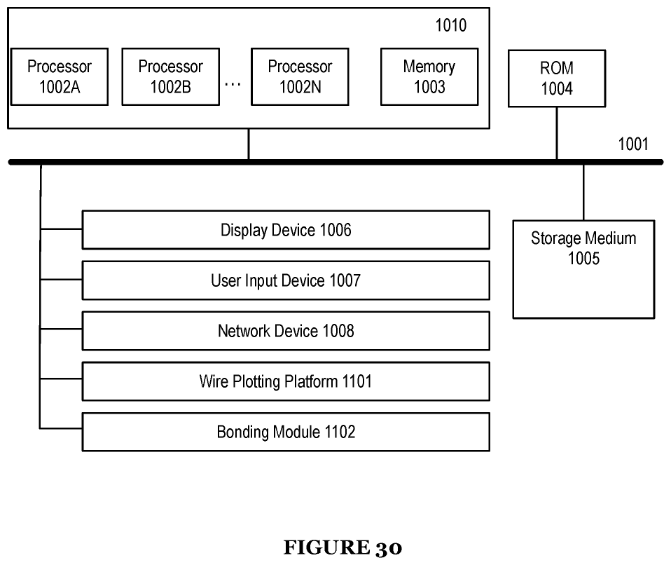

FIG. 30 is an exemplary computer architecture diagram of one implementation of the system. In some implementations, the system is implemented in a plurality of devices in communication over a communication channel and/or network. In some implementations, the elements of the system are implemented in separate computing devices. In some implementations, two or more of the system elements are implemented in same devices. The system and portions of the system may be integrated into a computing device or system that can serve as or within the system.

The communication channel 1001 interfaces with the processors 1002A-1002N, the memory (e.g., a random-access memory (RAM)) 1003, a read only memory (ROM) 1004, a processor-readable storage medium 1005, a display device 1006, a user input device 1007, and a network device 1008. As shown, the computer infrastructure may be used in connecting the wire plotting platform 1101, the bonding module 1102 and/or other suitable computing devices.

The processors 1002A-1002N may take many forms, such CPUs (Central Processing Units), GPUs (Graphical Processing Units), microprocessors, ML/DL (Machine Learning/Deep Learning) processing units such as a Tensor Processing Unit, FPGA (Field Programmable Gate Arrays, custom processors, and/or any suitable type of processor.

The processors 1002A-1002N and the main memory 1003 (or some sub-combination) can form a processing unit 1010. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip). In some embodiments, the processing unit includes one or more of the elements of the system.

A network device 1008 may provide one or more wired or wireless interfaces for exchanging data and commands between the system and/or other devices, such as devices of external systems. Such wired and wireless interfaces include, for example, a universal serial bus (USB) interface, Bluetooth interface, Wi-Fi interface, Ethernet interface, near field communication (NFC) interface, and the like.

Computer and/or Machine-readable executable instructions comprising of configuration for software programs (such as an operating system, application programs, and device drivers) can be stored in the memory 1003 from the processor-readable storage medium 1005, the ROM 1004 or any other data storage system.

When executed by one or more computer processors, the respective machine-executable instructions may be accessed by at least one of processors 1002A-1002N (of a processing unit 1010) via the communication channel 1001, and then executed by at least one of processors 1001A-1001N. Data, databases, data records or other stored forms data created or used by the software programs can also be stored in the memory 1003, and such data is accessed by at least one of processors 1002A-1002N during execution of the machine-executable instructions of the software programs.

The processor-readable storage medium 1005 is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like. The processor-readable storage medium 1005 can include an operating system, software programs, device drivers, and/or other suitable sub-systems or software.

As used herein, first, second, third, etc. are used to characterize and distinguish various elements, components, regions, layers and/or sections. These elements, components, regions, layers and/or sections should not be limited by these terms. Use of numerical terms may be used to distinguish one element, component, region, layer and/or section from another element, component, region, layer and/or section. Use of such numerical terms does not imply a sequence or order unless clearly indicated by the context. Such numerical references may be used interchangeable without departing from the teaching of the embodiments and variations herein.

As a person skilled in the art will recognize from the previous detailed description and from the figures and claims, modifications and changes can be made to the embodiments of the invention without departing from the scope of this invention as defined in the following claims.

We claim:

1. A system for an additive platform for a wire-wound power transmission construct comprising:
a wire comprising:
an interior metal core and
an adhesive coating;
a wire plotting platform, that shapes and deposits the wire in a moving region of wire deposition, comprising:
wire deposition components 122 and
positioning components 124 that includes an actuation system with at least two degrees of freedom, and
a bonding module, comprising a mechanism that activates the adhesive coating, such that the wire anneals to itself or to other components, in the region of wire deposition concurrent to deposition of the wire.

2. The system of claim 1, wherein the bonding module comprises a laser module, directed at the region of wire deposition, enabled to heat the wire such that the wire anneals to itself or to other components in the region of deposition.

3. The system of claim 2, wherein the wire plotting platform includes a feeding mechanism that draws the wire and feeds it to a plotting head of the wire plotting platform.

4. The system of claim 2, wherein the wire metal core is approximately between 1 μm to 500 μm.

5. The system of claim 2, further comprising a control module configured to control the wire plotting platform wherein an applicator head of the wire plotting platform deposits the wire in a 2D winding pattern.

6. The system of claim 5, wherein the system further comprises a third degree of freedom, wherein the control module is configured to integrate the actuation of the applicator head with actuation of a base platform, enabling construction of a 3D winding pattern.

7. The system of claim 2, wherein the wire further comprises an insulating layer situated on the exterior of the metal core.

8. The system of claim 2, wherein the metal core comprises a ferromagnet.

9. The system of claim 9, wherein the ferromagnet comprises mu-metal.

10. The system of claim 2, further comprising a multifilar interleaving transformer construct.

11. The system of claim 10, wherein the multifilar interleaving transformer construct comprises a wireless power transformer.

12. A method for producing a multifilar wire composition comprises using laser aided deposition comprises:
depositing a wire, wherein the wire has an outer adhesive coating;
bonding the wire, thereby activating the outer adhesive coating of the wire in a localized region of deposition; and
controlling at least a 2D relative position of wire deposition relative to a deposition plate.

13. The method of claim 12, wherein bonding the wire comprises directing a laser to a region proximal to the localized region of deposition.

14. The method of claim 13, wherein the controlling at least a 2D relative position of wire deposition, comprises depositing the wire with a 20 micron precision, such that repeated implementations of the method to make the same construct will create identical constructs to approximately 20 microns.

15. The method of claim 14, wherein the controlling at least a 2D relative position of wire deposition comprises creating a wire interweaving.

16. The method of claim 14, wherein the controlling at least a 2D relative position of wire deposition includes controlling a third degree of freedom, comprising controlling a separate degree of actuation relative to wire deposition.

17. The method of claim 14, wherein the controlling the at least 2D relative position of wire deposition relative to the deposition plate comprises controlling the at least 2D relative position of wire deposition relative to the deposition plate in coordination with depositing of the wire to form a Litz wire coil arrangement.

18. The method of claim 14, wherein the controlling the at least 2D relative position of wire deposition relative to the deposition plate comprises controlling the at least 2D relative position of wire deposition relative to the deposition plate in coordination with depositing of the wire to form a wireless power transformer.

19. The method of claim 14, wherein the wire includes a magnetic core, and wherein controlling the at least 2D relative position of wire deposition relative to the deposition plate comprises controlling the at least 2D relative position of wire deposition relative to the deposition plate in coordination with depositing of the wire and forming a coil with an interleaving magnetic core.

20. The method of claim 19, wherein the magnetic core has a thickness between 1 μm to 500 μm and depositing the wire comprises depositing multiple wire strands thereby forming multifilar interleaving coils.
